(19) United States
(12) Patent Application Publication
(10) Pub. No.: US 2012/0275024 A1
(43) Pub. Date: Nov. 1, 2012

(54) POLARIZER ASSEMBLY WITH ADHESIVE LAYERS

(75) Inventors: Vincent P. Marzen, Robins, IA (US); James D. Sampica, Springville, IA (US); Paul R. Nemeth, Springville, IA (US); Tracy J. Barnidge, Marion, IA (US)

(73) Assignee: Rockwell Collins, Inc.

(21) Appl. No.: 13/095,787

(22) Filed: Apr. 27, 2011

(51) Int. Cl. G02B 5/30; B32B 37/00

(52) U.S. Cl. 359/488.01; 359/492.01; 156/60

(57) ABSTRACT

A film assembly includes a polarizer having a first side and a second side opposite the first side; a first layer of adhesive bonded to the first side of the polarizer; and a second layer of adhesive bonded to a second side of the polarizer. The first and second layers of adhesive and the polarizer form a rollable film.

### BACKGROUND

The present disclosure relates generally to the field of laminated assemblies, and more particularly, to systems and methods related to manufacturing polarizer assemblies having one or more adhesive layers.

Conventionally, laminated display assemblies such as liquid crystal displays include one or more polarizing films and additional components such as cover glasses and/or touch screen displays. There are challenges associated with producing such laminated display assemblies.

### SUMMARY

One embodiment relates to a film assembly comprising a polarizer having a first side and a second side opposite the first side; a first layer of adhesive bonded to the first side of the polarizer; and a second layer of adhesive bonded to a second side of the polarizer; wherein the first and second layers of adhesive and the polarizer form a rollable film.

Another embodiment relates to a method for making a laminated assembly, the method comprising providing a flexible polarizer; providing a first adhesive layer; laminating the first adhesive layer to a first side of the flexible polarizer; providing a second adhesive layer; and laminating the second adhesive layer to a second side of the flexible polarizer opposite the first side to form a flexible film.

Another embodiment relates to a film assembly comprising a flexible polarizer having a first side and a second side opposite the first side; a first layer of pressure sensitive adhesive bonded to the first side of the flexible polarizer; and a second layer of pressure sensitive adhesive bonded to a second side of the flexible polarizer; wherein the first and second layers of pressure sensitive adhesive and the flexible polarizer form a rollable film.

### BRIEF DESCRIPTION OF THE DRAWINGS

FIG. 1 is a schematic representation of a display assembly according to an exemplary embodiment.

FIG. 2 is an exploded view of the display assembly of FIG. 1 according to an exemplary embodiment.

FIG. 3 is an exploded cross-section view of the display assembly of FIG. 1 according to an exemplary embodiment.

FIG. 4 is a cross-section view of a film assembly for use in the display assembly of FIG. 1 according to an exemplary embodiment.

FIG. 5 is a flow chart of method of making a polarizer assembly and display assembly according to an exemplary embodiment.

FIG. 6 is a schematic representation of a system for applying adhesive layers to a polarizing film according to an exemplary embodiment.

FIG. 7 is a schematic representation of a rigid-to-rigid lamination process according to an exemplary embodiment.

### DETAILED DESCRIPTION OF EXEMPLARY EMBODIMENTS

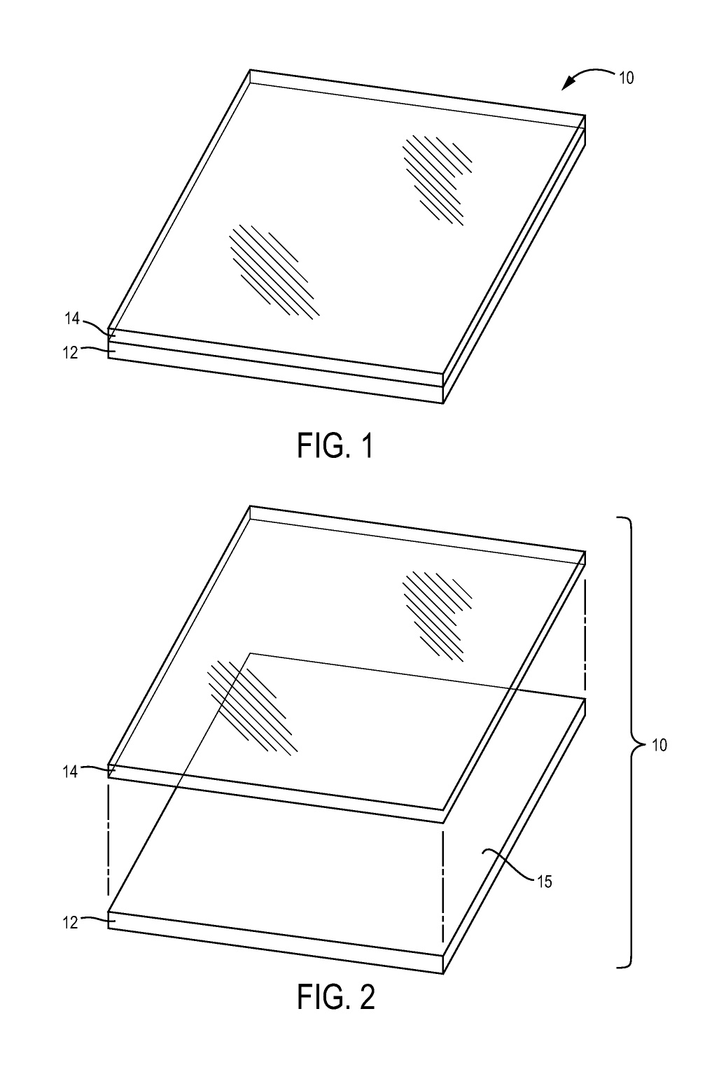

Referring to FIGS. 1-2, a display assembly 10 is shown according to an exemplary embodiment. Display 10 may include a wide variety of display assemblies, including LCD or OLED assemblies, touch screen display assemblies, and the like. Display assembly 10 may be used in a wide variety of applications, including vehicle displays, commercial/industrial displays, etc. Various embodiments disclosed herein are directed to facilitating the manufacturing of various display assemblies such as display assembly 10.

According to an exemplary embodiment, display assembly 10 includes a display 12 and a cover assembly 14. Display 12 may be a generally planar display assembly, and may be a rigid, semi-rigid, or flexible display. For example, in some embodiments, display 12 is or includes a liquid crystal display (LCD) assembly. In other embodiments, other types of displays may be used. In one embodiment, cover assembly 14 is laminated to a surface 15 of display 12. Cover assembly 14 may comprise a variety of components, either individually, or in combination, including a cover glass (e.g., a rigid or semi-rigid and generally transparent substrate, etc.), a touch screen display (e.g., configured to receive inputs via a stylus, a fingertip, etc.), optical enhancement or retardation films, and the like.

Traditional methods of applying cover assemblies involve multiple lamination steps of differing types. For example, in order to bond a cover glass to an LCD display, an adhesive would first be cut to size and then laminated to a surface of the display or cover glass(e.g., via a flexible-to-rigid lamination process), after which the cover glass would then be laminated to the display via the adhesive (e.g., via a rigid-to-rigid lamination process). Various embodiments herein are directed to assemblies and methods of assembly that may reduce the number of steps involved, and therefore reduce the time and cost required in connection with bonding cover assemblies to displays such as LCD displays (e.g., by reducing the number of cutting operations required to otherwise cut individual components such as an adhesive and a polarizer film to specific sizes).

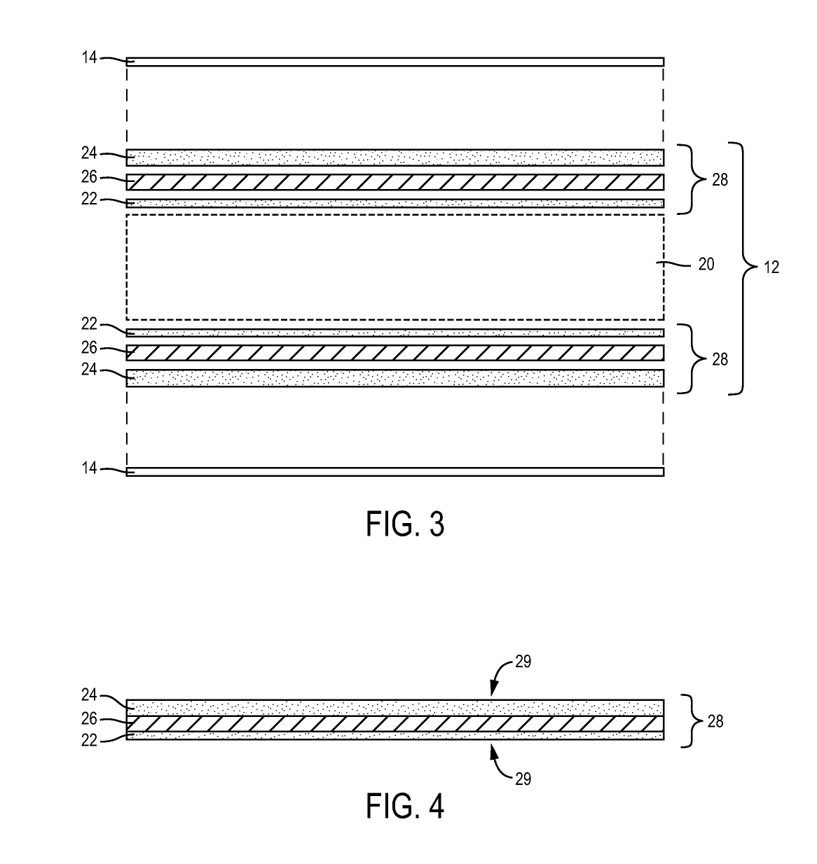

Referring now to FIG. 3, an exploded view of the display assembly of FIG. 1 is shown in greater detail according to an exemplary embodiment. As indicated above, display assembly 10 includes display 12 and one or more cover assemblies 14. In one embodiment, display 12 includes a liquid crystal display including polarizers 26 and other display components 20 such as glass substrates, a liquid crystal, etc. For example, according to one embodiment, display 12 may include a first polarizer, a glass substrate, a liquid crystal, a second glass substrate, and a second polarizer. Display 12 may also include a rear reflective surface and/or light source.

In some embodiments, as shown in FIGS. 3-4, polarizer 26 is provided in the form of a polarizer assembly 28. Polarizer assembly 28 may include a first adhesive layer 22 bonded to a first surface of polarizer 26 and a second adhesive layer 24 bonded to a second surface of polarizer 26 opposite the first surface. In some embodiments, one or both of first adhesive layer 22 and second layer 24 may comprise a pressure sensitive adhesive (PSA). In other embodiments, other suitable types of adhesives may be used for first adhesive layer 22 and/or second adhesive layer 24, such as acrylic-base adhesives, silicone epoxy adhesives, or adhesives having other suitable chemistry. Polarizer 26 may be a flexible polarizer and the PSA may be optically clear. Furthermore, polarizer 26 may be linear polarizer, or alternatively, a circular polarizer (e.g., to be laminated to an OLED and/or a cover glass, touch screen, etc.).

According to an exemplary embodiment, first adhesive layer 22 and second adhesive layer 24 may have substantially similar thicknesses, while in other embodiments, first adhesive layer 22 and second layer 24 may have different thicknesses. For example, first adhesive layer 22 may be a relatively thicker adhesive layer (e.g., a relatively thicker layer of PSA) and second adhesive layer 24 may be a relatively thinner adhesive layer (e.g., a relatively thinner layer of PSA). In one embodiment, first adhesive layer 22 may be a relatively thinner layer of pressure sensitive adhesive having a thickness of approximately 0.001 inches, and second adhesive layer 24 may be a relatively thicker layer of pressure sensitive adhesive having a thickness of approximately 0.007 inches. In other embodiments, the thicknesses of first adhesive layer 22 and second adhesive layer 24 may be varied (e.g., in one embodiment, second adhesive layer 24 is approximately 0.040 inches thick, etc.). In other embodiments, one or both adhesive layers may be as thick as 0.060 inches, 0.100 inches, or greater than 0.100 inches.

According to various exemplary embodiments, adhesive layers 22, 24 may include a variety of suitable pressure sensitive adhesives. Generally, pressure sensitive adhesives are adhesives (e.g., provided in rolled form, sheet form, etc.) that are configured to form a bond when pressure is applied (e.g., in the case of applying a compressive force to two rolled goods having a layer of pressure sensitive adhesive therebetween). The pressure sensitive adhesive may include a protective layer (e.g., a layer 29 shown in FIG. 4) that keeps the surface of the pressure sensitive adhesive free from debris (e.g., prior to joining of mating components, etc.).

As indicated earlier, in some embodiments, first adhesive layer 22 (e.g., which may be a relatively thinner adhesive layer) is configured to provide a bond between a first surface of polarizer 26 and a liquid crystal display component (e.g., a glass substrate component of an LCD) to form an LCD display. Second adhesive layer 24 is configured to provide a bond between a second surface of polarizer 26 and a cover assembly or other component (e.g., cover assembly 14 shown in FIG. 1). According to various alternative embodiments, first adhesive layer 22 and/or second adhesive layer 24 may provide bonding between polarizer 26 and different components than those discussed herein (e.g., glass microsheets, plastic substrates, touch screens, patterned retarder glass plates (3-D, stereoscopic), lenticular lens arrays for glasses-free 3-D (autostereo), and the like).

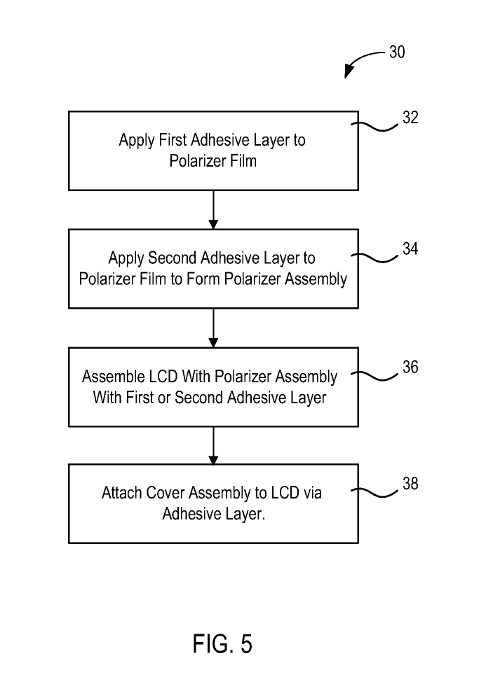

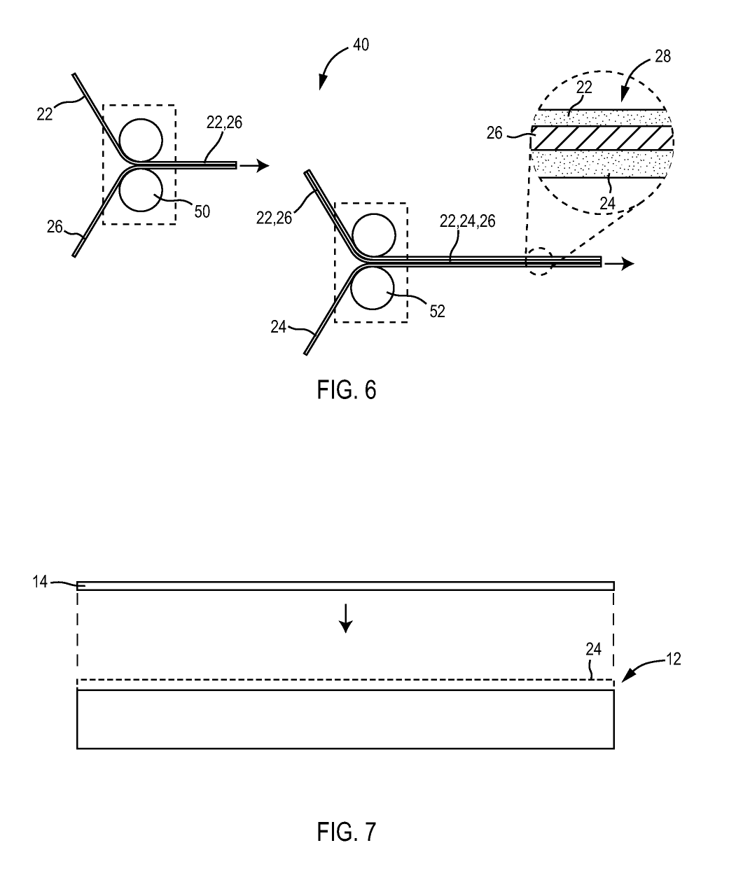

Referring now to FIG. 5 a method of making a polarizer assembly such as polarizer assembly 28 and a display utilizing a polarizer assembly is shown according to an exemplary embodiment. As shown in FIG. 5, a first adhesive layer is applied to a first side of a polarizer film (step 32). For example, first adhesive layer 22 may be applied to polarizer 26. In some embodiments, first adhesive layer 22 may be laminated to polarizer 26 using a roll-to-roll lamination process and a roll-to-roll lamination device 50, as shown in FIG. 6. In other embodiments, one or more layers of adhesive may coated directly onto polarizer 26 using a suitable coating process. As discussed herein, first adhesive layer 22 may be a relative thin layer of pressure sensitive adhesive. Next, a second adhesive layer is applied to a second side of the polarizer film (step 34). For example, second adhesive layer 24 may be applied to polarizer 26. In some embodiments, second adhesive layer 24 may be laminated to polarizer 26 using a roll-to-roll lamination process and a roll-to-roll lamination device 52, as shown in FIG. 6.

In some embodiments, once the first and second adhesive layers are applied to the polarizer, the resulting polarizer assembly may be rolled or otherwise stored for later usage/additional processing (e.g., cutting, etc.). In some embodiments, the resulting polarizer is a flexible and/or rollable film suitable for future lamination via roll-to-roll processes, flexible-to-rigid lamination processes, etc.

Referring further to FIG. 5, in some embodiments, the polarizer assembly may be incorporated into a display assembly. For example, the polarizer assembly may be bonded to other components forming a liquid crystal display (step 36). In contrast to typical LCD displays, which are provided without an outward-facing layer of adhesive (e.g., second adhesive layer 24) provided for bonding of additional components, an LCD assembly provided with a polarizer assembly such as polarizer assembly 28 is prepared to receive additional components such as cover assembly 14 (e.g., a cover glass, a touch screen, etc.) without additional intermediate steps of lamination, etc.

A cover assembly may be bonded to the polarizer assembly via the second adhesive layer (step 38). For example, cover assembly 14, such as a cover glass, touch screen, or other component, may be bonded to the LCD assembly. Any protective layer, such as a protective layer 29 shown in FIG. 4, is first removed to expose the second adhesive layer. Next, the display may be bonded to the cover assembly using a suitable lamination process. In some embodiments, a dry film lamination process (see FIG. 7) may be utilized to provide a proper rigid-to-rigid lamination of the display and the cover assembly. Exemplary dry film lamination processes are shown and illustrated in U.S. application Ser. No. 12/009,375, filed Jan. 18, 2008, which is incorporated by reference herein. According to various alternative embodiments, other suitable forms of lamination may be utilized.

Referring to FIG. 6, a system 40 for assembling a polarizer assembly such as polarizer assembly 28 is shown according to an exemplary embodiment. A first lamination device 50 (e.g., a roll laminator, etc.) may be used to laminate first adhesive layer 22 to polarizer 26 (e.g., via a roll-to-roll lamination process). A second lamination device 52 (e.g., a second roll laminator, etc.) may be used to laminate second adhesive layer 24 to polarizer 26, adhesive 22, thereby forming polarizer assembly 28. It should be noted that while FIG. 6 shows two lamination devices 50, 52, according to various alternative embodiments, more or fewer lamination devices or other devices may be utilized. Furthermore, in some embodiments, the adhesive may be coated directly onto a surface of the polarizer.

For purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. Such joining may also relate to mechanical, fluid, or electrical relationship between the two components.

It is important to note that the construction and arrangement of the elements of the polarizer and display assembly as shown in the exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the embodiments. Accordingly, all such modifications are intended to be included within the scope of the present disclosure as defined in the appended claims. The order or sequence of any process or method steps may be varied or re-sequenced according to alternative embodiments. Other substitutions, modifications, changes, and/or omissions may be made in the design, operating conditions, and arrangement of the exemplary embodiments without departing from the spirit of the present disclosure.

What is claimed is:

1. A film assembly comprising:
a polarizer having a first side and a second side opposite the first side;
a first layer of adhesive bonded to the first side of the polarizer; and
a second layer of adhesive bonded to a second side of the polarizer;
wherein the first and second layers of adhesive and the polarizer form a rollable film.

2. The film assembly of claim 1, wherein the first and second layers have different thicknesses.

3. The film assembly of claim 2, wherein the first layer of adhesive has a thickness of approximately 0.001 inches and the second layer has a thickness of approximately 0.007 inches.

4. The film assembly of claim 1, wherein the first and second layers of adhesive are pressure sensitive adhesives.

5. The film assembly of claim 4, wherein the first and second layers of adhesive are applied to the polarizer assembly via a roll-to-roll lamination process.

6. The film assembly of claim 1, wherein the first layer of adhesive is configured to bond the polarizer to a liquid crystal display (LCD) assembly, and wherein the second layer of adhesive is configured to bond the polarizer to a generally rigid substrate assembly.

7. The film assembly of claim 6, wherein the generally rigid substrate assembly comprises at least one of a cover glass and a touchscreen display.

8. The film assembly of claim 1, further comprising a removable protective layer provided on an outside surface of at least one of the first and second adhesive layers.

9. A method for making a laminated assembly, the method comprising:
providing a flexible polarizer;
providing a first adhesive layer;
laminating the first adhesive layer to a first side of the flexible polarizer;
providing a second adhesive layer; and
laminating the second adhesive layer to a second side of the flexible polarizer opposite the first side to form a flexible film.

10. The method of claim 9, wherein at least one of the first and second adhesive layers is a pressure sensitive adhesive.

11. The method of claim 9, wherein the first adhesive layer has a thickness of approximately 0.001 inches and the second adhesive layer has a thickness of approximately 0.007 inches.

12. The method of claim 9, wherein at least one of the first adhesive layer and the second adhesive layer is laminated to the flexible polarizer using a roll-to-roll lamination process.

13. The method of claim 9, further comprising laminating the flexible film to a display component via the first adhesive layer to form a display assembly.

14. The method of claim 13, further comprising laminating the flexible film to a generally rigid substrate via the second adhesive layer to form a display assembly.

15. The method of claim 14, wherein the generally rigid substrate comprises at least one of a cover glass and a touch screen.

16. A film assembly comprising:
a flexible polarizer having a first side and a second side opposite the first side;
a first layer of pressure sensitive adhesive bonded to the first side of the flexible polarizer; and
a second layer of pressure sensitive adhesive bonded to a second side of the flexible polarizer;
wherein the first and second layers of pressure sensitive adhesive and the flexible polarizer form a rollable film.

17. The film assembly of claim 16, wherein the second layer of pressure sensitive adhesive is thicker than the first layer of pressure sensitive adhesive

18. The film assembly of claim 16, wherein the first and second layers of pressure sensitive adhesive are laminated to the flexible polarizer via roll-to-roll lamination processes.

19. The film assembly of claim 16, wherein the first layer of pressure sensitive adhesive is configured to bond the flexible polarizer to an LCD assembly, and wherein the second layer of pressure sensitive adhesive is configured to bond the flexible polarizer to a generally rigid substrate.

20. The film assembly of claim 16, further comprising a protective layer provided to an outside surface of at least one of the first layer of pressure sensitive adhesive and the second layer of pressure sensitive adhesive.
